(19) United States
(12) Patent Application Publication
(10) Pub. No.: US 2006/0010243 A1
(43) Pub. Date: Jan. 12, 2006

(54) Internet protocol network system for real-time data applications

(76) Inventor: Albert D. DuRee, Independence, MO (US)

Correspondence Address: SETTER OLLILA, LLC, 2060 BROADWAY, SUITE 300, BOULDER, CO, 80302, US

(21) Appl. No.: 10/750,723

(22) Filed: Dec. 31, 2003

Related U.S. Application Data
(60) Provisional application No. 60/438,135, filed on Jan. 6, 2003.

(51) Int. Cl. G06F 15/16

(52) U.S. Cl. 709/230; 709/237

(57) ABSTRACT

IP routes are established between route processors. The route processors change message addresses, so that signaling and data messages between users or between users and a soft switch are routed through the route processors. The route processors transfer data messages over the IP routes and monitor performance of the IP routes. The performance data is provided to a route manager that manages the IP routes to avoid undesirable service quality.

### RELATED CASES

This patent application claims the benefit of U.S. Provisional Patent Application 60/438,135; which is entitled “IP network route management system for real-time data applications”; which was filed on Jan. 6, 2003; and which is hereby incorporated by reference into this application.

### BACKGROUND

1. Field of Invention

The invention relates to communications technology, and specifically to Internet Protocol (IP) networks that transport real-time traffic, such as voice or video traffic.

2. Prior Art

FIG. 1 depicts a common arrangement in the prior art for establishing a session between two IP devices that send and receive real-time traffic. Before IP device 100 can make voice over IP (VoIP) calls using soft switch 118, IP device 100 must go through a registration process. The registration process is used to identify IP device 100 and register its IP address with soft switch 118, so other IP devices can obtain and use this IP address to exchange packets with IP device 100.

IP device 100 sends a packet that contains an IP registration message to the IP address of soft switch 118 using connection 102 which connects to access router 106. Access router 106 examines the Transport Control Protocol (TCP)/IP header for the destination address and sends the packet using connection 108 which connects to edge router 112. Edge router 112 examines the TCP/IP header destination address and sends it to soft switch 118 using connection 114.

Soft switch 118 processes the IP registration message and sends a packet containing a response message to the IP address of IP device 100 using connection 116 which connects to edge router 112. Edge router 112 examines the TCP/IP header for the destination address and sends the packet using connection 110 which connects to access router 106. Access router 106 examines the TCP/IP header for the destination address and sends the packet using connection 104 which connects to IP device 100.

When the exchange of IP registration messages is complete, IP device 100 is ready to make VoIP calls. FIG. 15 also illustrates the registration message flow. The same IP registration process must also takes place between soft switch 118 and IP device 136 before IP devices 100 and 136 can call each other.

When IP device 100 wants to call IP device 136, IP device 100 sends a connection request message to soft switch 118 to obtain the IP address to use for the voice session. IP device 100 sends a packet that contains the connection request message to the IP address of soft switch 118 using connection 102 which connects to access router 106. Access router 106 examines the TCP/IP header for the destination address and sends the packet using connection 108 which connects to edge router 112. Edge router 112 examines the TCP/IP header destination address and sends the packet to soft switch 118 using connection 114.

Soft switch 118 processes the connection request message and sends a packet that contains a response message that indicates the IP address of IP device 136. Soft switch 118 sends this packet to the IP address of IP device 100 using connection 116 which connects to edge router 112. Edge router 112 examines the TCP/IP header for the destination address and sends the packet using connection 110 which connects to access router 106. Access router 106 examines the TCP/IP header for the destination address and sends the packet using connection 104 which connects to IP device 100. When this exchange of connect messages complete, IP device 100 is ready to initiate a VoIP call using the IP address of IP device 136 which was determined by soft switch 118.

IP device 100 sends a packet that contains a connection request message to the IP address of IP device 136 using connection 102 which connects to access router 106. Access router 106 examines the TCP/IP header destination address and sends the packet using connection 108 which connects to edge router 112. Edge router 112 examines the TCP/IP header destination address and sends it to connection 120 that connects to edge router 124.

Edge router 124 examines the TCP/IP header destination address and sends the packet using connection 126 which connects to access router 130. Access router 130 examines the TCP/IP header destination address and sends the packet using connection 132 which connects to IP device 136.

IP device 136 processes the connection request message and sends a packet containing a response message that indicates either an acceptance or rejection of the call to the IP address of IP device 100 using connection 134 which connects to access router 130. Access router 130 examines the TCP/IP header for the destination address and sends the packet using connection 128 which connects to edge router 124.

Edge router 124 examines the TCP/IP header for the destination address and sends the packet using connection 122 which connects to edge router 112. Edge router 112 examines the TCP/IP header for the destination address and sends the packet using connection 110 which connects to access router 106. Access router 106 examines the TCP/IP header for the destination address and sends the packet using connection 104 which connects to IP device 100. FIG. 16 illustrates this message flow.

When the exchange of connection messages is complete, IP devices 100 and 136 are ready to exchange IP Real Time Protocol (RTP) packets containing voice data. The RTP packets will take the same path through the IP network, if the backbone network is set up using Traffic Engineered Resource Reservation Protocol (TE-RSVP) tunnels.

Currently, the management of network routes used for transporting real-time traffic is done by over-provisioning the route bandwidth to ensure that there will always be capacity available for transporting the real-time traffic. The current IP Quality-of-Service (QoS) and over-provisioning that is being used does not address whether the route is presently usable for this type of traffic. It relies on IP QOS protocols using tunnels and alternate routes which the routers select to get the traffic to its destination. There are times when the network becomes congested and this technique does not work due to the delay requirements of real-time data traffic.

Today, information about the performance and delay of an IP tunnel route is difficult to obtain. Information about the performance and delay of the connection between the IP device and the edge router is also difficult to obtain. When problems occur, it is labor intensive to determine what is wrong and what to do to correct the problem. Over-provisioning the network is an expensive solution, but the only one currently available, because an effective route management system for real-time traffic is not implemented as part of the IP protocol suite. This lack of a route management tool has impeded the use of newer soft switch VoIP technology.

While IP QOS provides performance information to the routers in the network, IP QoS does not provide the soft switch the same performance data. Soft switches currently do not have a method to determine if the route being used for a session is usable—whether the route is up, down, or overloaded. The soft switch cannot select an alternate network route for the traffic.

### SUMMARY

Some examples of the invention include a method of operating a communication system for users, where the communication system includes route processors, an Internet Protocol (IP) network, and a soft switch. The method comprises establishing IP routes between the route processors through the IP network. The route processors change signaling message addresses in signaling messages that are transferred between the users and the soft switch to direct the signaling messages through the route processors. The route processors change data message addresses in data messages that are transferred between the users to direct the data messages through the route processors. The data messages are transferred between the route processors over the IP routes. The route processors monitor the performance of the IP routes.

Some examples of the invention include a method of operating a communication system that comprises: establishing an Internet Protocol (IP) route through an IP system between a first route processor and a second route processor; in the first route processor, receiving a first registration message from a first user where the first registration message has a first address as a first registration message source address and a second address as a first registration message destination address, processing the first registration message to change the first address to a third address and to change the second address to a fourth address, and transferring the first registration message; in the second route processor, receiving a second registration message from a second user where the second registration message has a fifth address as a second registration message source address and the sixth address as a second registration message destination address, processing the second registration message to change the fifth address to a seventh address and to change the sixth address to the fourth address, and transferring the second registration message; in the soft switch, receiving and processing the first registration message to register the first user at the third address and receiving and processing the second registration message to register the second user at the seventh address; in the first route processor, receiving a first request message from the first user where the request message requests a session with the second user and has the first address as a first request message source address and the second address as a first request message destination address, processing the first request message to change the first address to the third address and to change the second address to the fourth address, and transferring the first request message; in the soft switch, receiving and processing the first request message to transfer a first response message that associates the second user with the seventh address and has the fourth address as a first response message source address and the third address as a first response message destination address; in the first route processor, receiving and processing the first response message to change the fourth address to the second address and to change the third address to the first address, and transferring the first response message to the first user; in the first route processor, receiving a second request message from the first user where the second request message has the first address as a second request message source address and the seventh address as a second request message destination address, processing the second request message to change the first address to the third address, and transferring the second request message; in the second route processor, receiving and processing the second request message to change the seventh address to the fifth address and transferring the second request message; in the second route processor, receiving and processing a second response message from the second user where the second response message has the fifth address as a second response message source address and the third address as a second response message destination address, processing the second response message to change the fifth address to the seventh address, and transferring the second response message; in the first route processor, receiving and processing the second response message to change the third address to the first address, and transferring the second response message; in the first route processor, receiving a first data message from the first user where the first data message has the first address as a first data message source address and the seventh address as a first data message destination address, processing the first data message to change the first address to the third address, and transferring the first data message over the IP route; in the second route processor, receiving and processing the first data message to change the seventh address to the fifth address and transferring the first data message; in the second route processor, receiving and processing a second data message from the second user where the second data message has the fifth address as a second data message source address and the third address as a second data message destination address, processing the second data message to change the fifth address to the seventh address, and transferring the second data message over the IP route; in the first route processor, receiving and processing the second data message to change the third address to the first address, and transferring the second data message; and in the first route processor and the second route processor, monitoring performance of the IP route.

Note that the terms first, second, third, etc. are used to distinguish addresses and messages and do not necessarily indicate sequence.

In some examples of the invention, the registration messages, the request messages, and the response messages comprise Session Initiation Protocol messages.

In some examples of the invention, the registration messages, the request messages, and the response messages comprise H.323 messages.

In some examples of the invention, the data messages comprise Real-Time Protocol messages.

In some examples of the invention, the IP route comprises a Resource Reservation Protocol tunnel.

In some examples of the invention, monitoring the performance of the IP route comprises monitoring packet delay.

In some examples of the invention, the method further comprises establishing another IP route through the IP system between the first route processor and the second route processor and using the other IP route for subsequent data transfer between the first route processor and the second route processor based on the monitored performance of the first IP route.

In some examples of the invention, the method further comprises transferring information indicating performance of the IP route from the first route processor and the second route processor to a route manager.

### DESCRIPTION OF DRAWINGS

FIG. 1 depicts an IP real-time data application in an example of the prior art.

FIG. 2 depicts a remote route configuration in an example of the invention.

FIG. 3 is an overview of the WARP apparatus in an example of the invention.

FIG. 4 is a view of the IP management message processing in an example of the invention.

FIG. 5 is a view of the message processing for messages received from a VPN trunk in an example of the invention.

FIG. 6 is a view of message processing for messages from a device in an example of the invention.

FIG. 7 is a view of message processing for messages from a soft switch in an example of the invention.

FIG. 8 is a view of the WARP controller in an example of the invention.

FIG. 9 depicts a trunk data table used by the WARP in an example of the invention.

FIG. 10 depicts trunk status data maintained by the WARP in an example of the invention.

FIG. 11 depicts a source IP address table used by the WARP in an example of the invention.

FIG. 12 depicts VPN trunk routing tables used by the WARP in an example of the invention.

FIG. 13 depicts how the VPN trunk message is created in an example of the invention.

FIG. 14 depicts the network route manager processor in an example of the invention.

FIG. 15 depicts a current registration process in an example of the prior art.

FIG. 16 depicts a voice session message flow in an example of the prior art.

FIG. 17 depicts a WARP registration method in an example of the invention.

FIG. 18 depicts a WARP set up source end message flow in an example of the invention.

FIG. 19 depicts a WARP set up far end message flow in an example of the invention.

FIG. 20 depicts a WARP response and near end RTP message flows in an example of the invention.

FIG. 21 depicts a WARP RTP far end message flow in an example of the invention.

FIG. 22 depicts a WARP RTP near end message flow in an example of the invention.

FIG. 23 depicts a variable data table used by the WARP in an example of the invention.

FIG. 24 depicts a local route configuration in an example of the invention.

### DETAILED DESCRIPTION

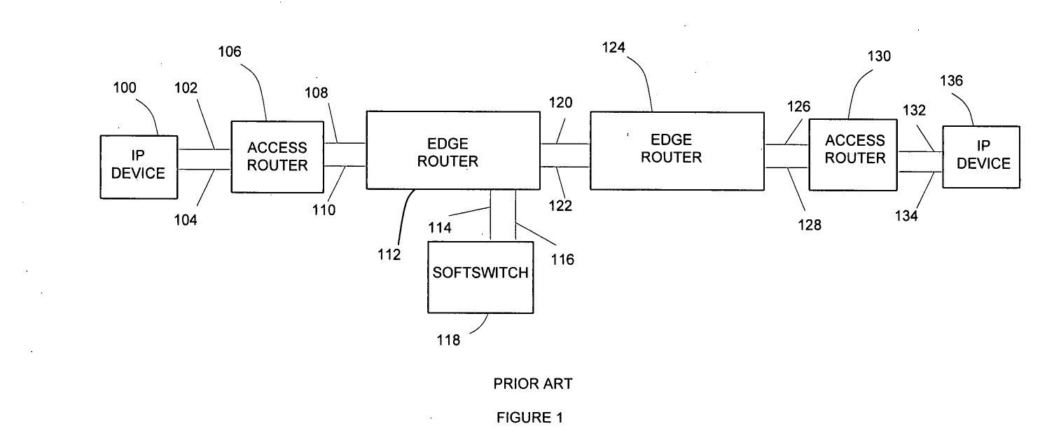

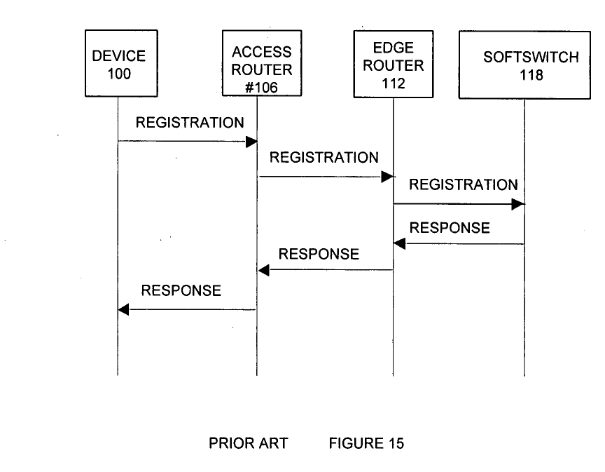

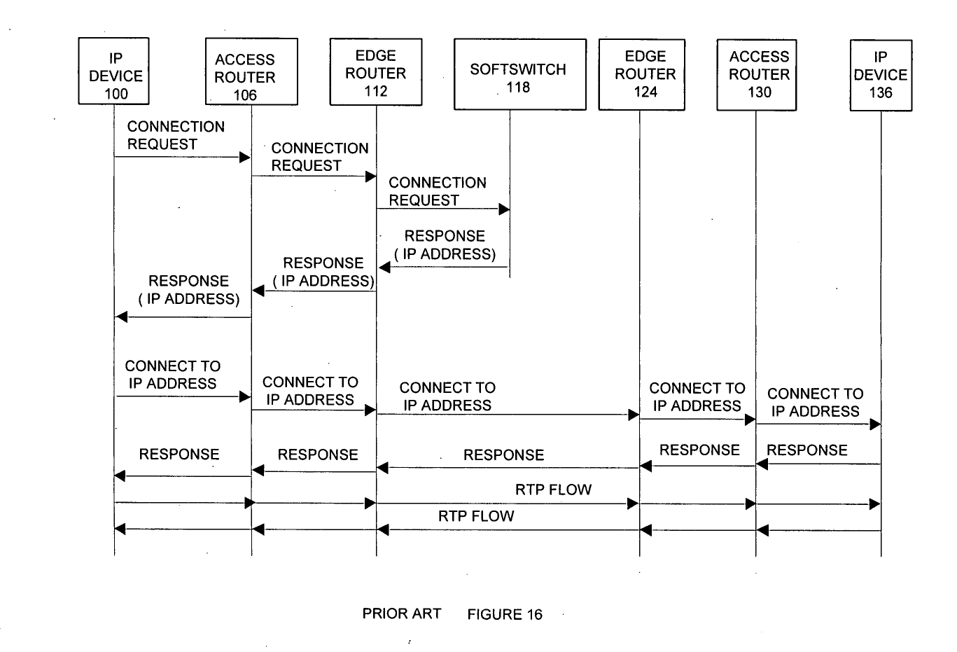

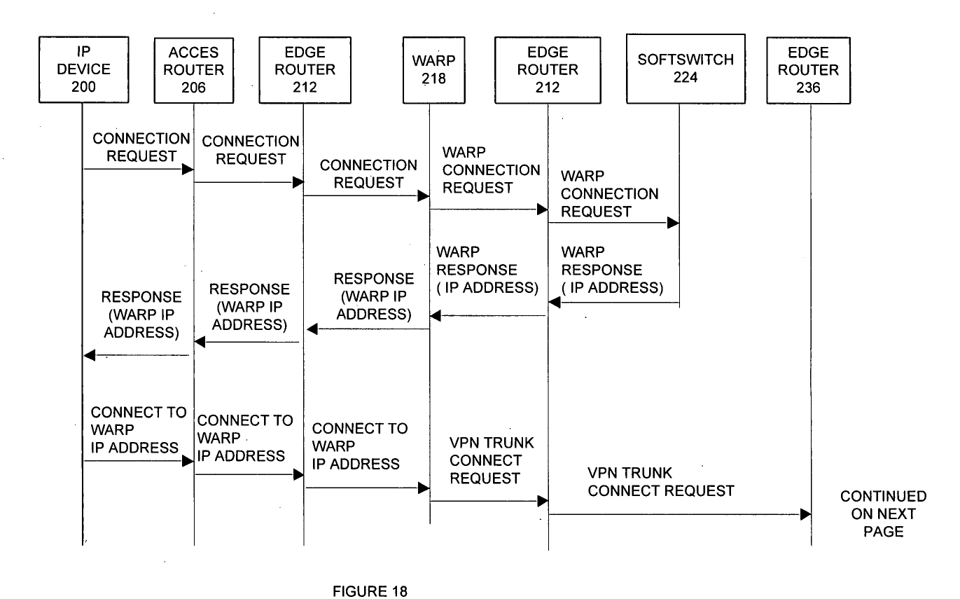

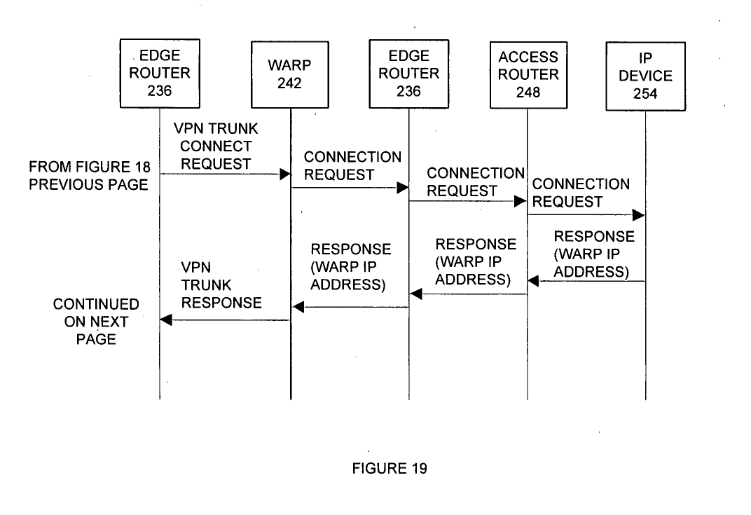

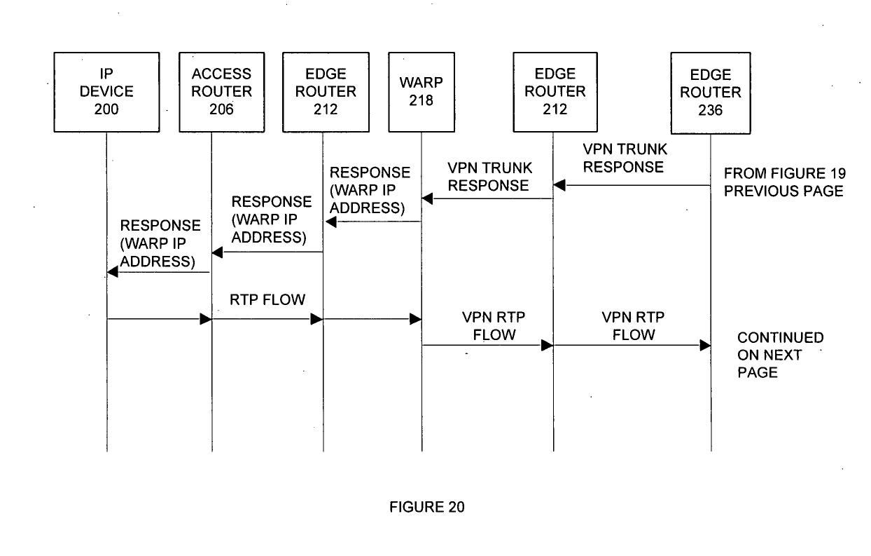

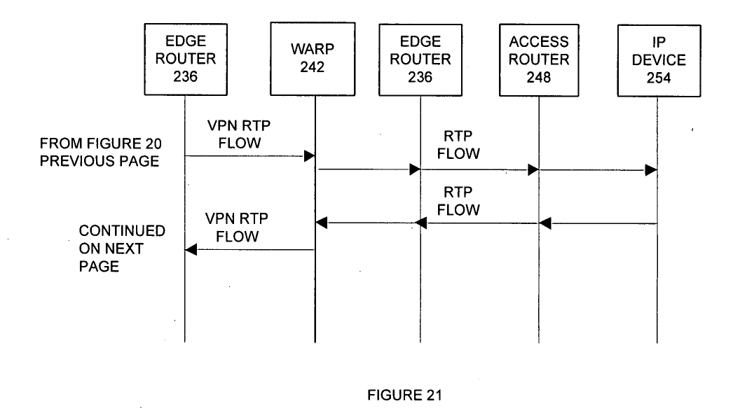

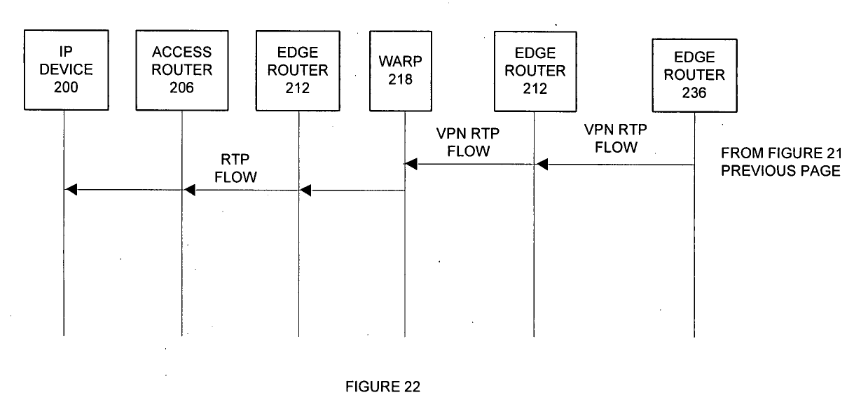

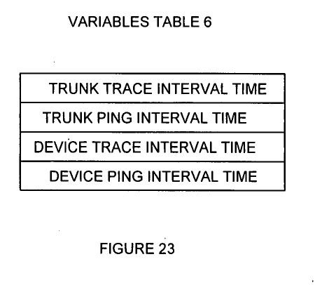

FIGS. 1-24 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below from the various examples can be combined in various ways to form multiple variations of the invention. As a result, the invention is not limited to the specific examples described below, but only by the claims and their equivalents.

Some examples of the invention provide communication system to manage the IP routes at the edge and across the backbone network. The communication system collects performance data on each IP device to edge router path. The communication system collects performance and traffic loading data needed to manage the real-time IP traffic sessions. The communication system sets up and controls TE-RSVP tunnel routes that are used to send the real-time packets across the backbone network. The communication system provides performance information to the operator through a Graphical User Interface (GUI) or to the soft switch using an Application Programming Interface (API). A soft switch can take advantage of the information and route control implemented by the communication system by implementing an XML database API interface. The communication system uses existing IP protocols and IP QOS protocol capabilities to accomplish real-time route management with minimal effects on the network routers.

The communication system forces all signaling and data packets from an IP device to be routed through a new apparatus identified as a Wide Area route Processor (WARP). The IP device must first have registered with its soft switch via the WARP. The IP address that the IP device uses for registration points to the WARP rather than the soft switch which allows the WARP to intercept and process the registration messages and signaling packets that are sent to the soft switch from the IP device, and then to route them to the soft switch. The soft switch receives the registration packet, but the registration packet now has a substitute source IP address assigned by the WARP in the source field of the TCP/IP header that causes the response message to be returned to the WARP. The WARP routes the response message to the IP device using that device's IP address. This allows the soft switch to perform its functions, but the soft switch has a substitute WARP IP address for the IP device rather than the IP device's actual IP address.

In the communication system, each edge router in the network is connected to a WARP. The WARP is connected to the IP network by one or more edge router ports. All access routers that connect the IP devices to the network by one of their ports must also be connected to an edge router port.

The communication system has a new apparatus identified as a Network route Manager Processor (NRMP). The NRMP is connected to the IP network by one or more ports on one of the edge routers in the network. There is one active NRMP for each soft switch that services a group of IP devices. The NRMP manages all of the WARPs that provide service for the same group of IP devices as the soft switch. The NRMP sends the WARP its IP address assignments and the bandwidth reservation requirement for each of its TE-RSVP trunk routes.

Table Data received from NRMP
Range of WARP IP addresses that are used as substitute addresses for the IP address of IP devices.
VPN trunk number(s) and the IP address used by the near end and far end WARP and bandwidth assignments to create network TE-RSVP tunnel(s) between them.

At initialization, the trunk side of the WARP sets up VPN route(s) through the network to every other WARP using the TE-RSVP protocol to reserve a specific amount of bandwidth from one WARP to another through the IP network backbone. The VPN path provisioned in the network routers only knows about two IP addresses—for the WARPs at each end of the route. All real-time packet traffic is encapsulated in the data field of the UDP packets that are sent using these IP addresses.

The WARP sends a trace route packet and monitors each VPN route periodically via a trace route function and ping function to detect any changes in the configuration of the routers in the route's path. The WARP collects data on the VPN route delay by a TRef timestamp value sent in every packet transmitted over the VPN trunk route. A ping packet is sent every N seconds when no user packets are being sent via the trunk, where N is a variable in one second increments. The WARP also records the number of real-time connections that are using the VPN trunk route.

The VPN trunk route data collected by the WARP are sent to the NRMP. The data from all WARPs are used to create GUI displays of the VPN trunk routes. One GUI display shows the “traced VPN route port by port” through all the network routers in that path. Another GUI display shows the “number of real-time connections using the VPN route port by port” through the network. A GUI can also display “over lapping route real-time trunk connections” by links. This provides the network operator the detailed data they are lacking today to manage the provisioning of sufficient bandwidth for the TE-RSVP links between routers, but avoids having to over-provision the routes. This also gives the operator the ability to view how the network is performing in near real-time and display problems that are detected by NRMP data analysis programs that process the collected data.

The WARPs may initiate multiple VPN routes. The NRMP sends the WARP the routes being made available and their assigned IP addresses (near end and far end) and which of these routes to use for sending traffic. The NRMP can send a message to the WARP instructing it to switch to another VPN route if the current VPN route fails or becomes overloaded. The NRMP VPN route data can be used to identify VPN route failure or overload conditions. A “trunk route status” GUI display allows the network operator to view the results of the analysis.

A trace route is sent by the WARPs to each registered IP device, every N seconds, where N is a variable in one-second increments. The data collected can be used to detect any changes in configuration of the routers in the route's path. The WARP collects data on the IP device route delay by pinging the device every N seconds, where N is a variable in one-second increments. The WARP records the trace and ping information that are returned. This information is sent to the NRMP where it can be used to calculate the number of connections using the same edge router access port. The NRMP can identify when a path becomes overloaded or has excessive delay and can display this via an “access route status” GUI.

When an IP device registers with the soft switch, the WARP assigns the IP device a substitute WARP IP address that is used to route its IP data and signaling packets through the WARP. These IP addresses are placed in trunk table 0. The information in trunk table 0 is sent to all other WARPs using a WARP trunk routing packet that is sent via the VPN trunk routes. WARPs store all the IP addresses and record the VPN trunk that they were received on in their trunk tables.

The network treats the WARP as though it were just another router in the network. WARPs exchange routing information with their adjacent edge router that shows it has a route to every substitute IP address. However, the route to all WARPs substitute IP addresses in the network has a hop count equal to one. This makes their route always the shortest path to any WARP IP address. The edge routers are configured to only send the substitute IP addresses to the shortest path.

The IP devices all have a substitute WARP IP address that is used in the destination field of the TCP/IP header when the IP devices send packets to one another. The substitute WARP IP address directs the network to send the packets to the WARP first, where they are processed and routed to their final destination. This also enables the WARP to encapsulate packets and send them via a TE-RSVP trunk when the packets are routed via the backbone network.

To make the discussion easier to follow, we use generic message types rather than the specific protocol messages used by the Session Initiation Protocol (SIP) or H.323 protocol that set-up a real-time data session. One skilled in the art will appreciate how this discussion applies to SIP or H.323. The discussion applies to any signaling protocol that first registers the IP addresses of the IP devices at a location server, and requires the IP devices that initiate sessions to obtain the IP addresses of the other IP devices on the sessions from a redirect server.

The communication system does not act as a signaling or data packet origination or termination point. Its purpose is to manage the routes that transfer packets through the access and backbone IP network. The communication system monitors the access and backbone routes and makes related performance and other data available to the network operator.

The communication system provides a method of managing the IP routes at the edge and across the backbone that are used for RTP Data applications. The method enables all IP packets sent by a device to be routed through a WARP so it can monitor and manage the route the packet takes to it destination. The communication system is comprised of WARPs and a NRMP to:

1) collect delay performance data, path usage data, and trace route data on the TE-RSVP tunnels;

2) collect delay performance data, route path usage data, and trace route data on the IP device to edge router access path;

3) manage TE-RSVP tunnels that are used to transport RTP data packets;

4) make the delay, trace and usage data it collects available to the network operator via a Graphic User Interface; and

5) make the delay, trace and usage data it collects available to soft switch systems via an XML database application interface.

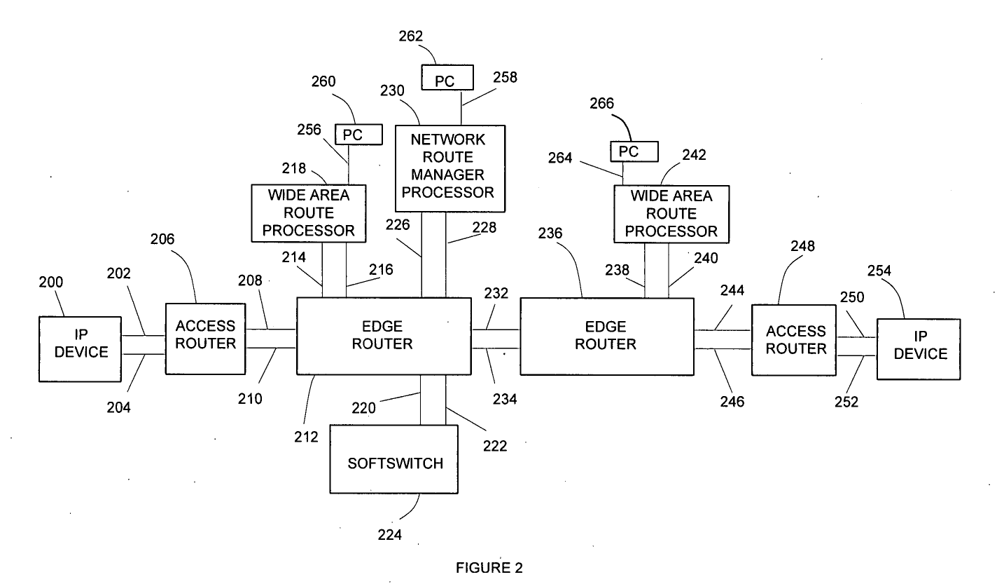

FIG. 2 depicts an example of the invention that is implemented using a small number of elements in the network to make the description easier to follow. One skilled in the art will know more complex network configurations would also work with the invention.

Before a new apparatus can be used, it must first be supplied with the data it requires to process IP traffic. In FIG. 2, NRMP 230 has a command line interface port 258 that connects to PC 262. The command line interface is used to input the IP addresses it will use to communicate with the Wide Area route Processors (WARPs) on the network. This interface may also be used to data fill the NRMP's data tables that will be sent to each WARP from the NRMP. After the data are entered, the NRMP is initialized and will communicate via its route control processes and network link connection 226 and 228 using its IP address to WARPs and NRMP GUI applications.

In FIG. 2, WARP 218 has a command line interface port 256 that connects to PC 260. The command line interface is used to input the IP address it will use to communicate with NRMP 230. This interface may also be used to data fill the WARP's data tables. After the data is entered, WARP 218 is initialized and will communicate with the NRMP via its WARP controller process and network link connection 214 and 216 which connects to edge router 212 which connects to NRMP 230 using network link connections 226 and 228.

In FIG. 2, WARP 242 has a command line interface port 264 that connects to PC 266. The command line interface is used to input the IP address it will use to communicate with NRMP 230. This interface may also be used to data fill the WARP's tables. After the data are entered, WARP 242 is initialized and will communicate with the NRMP via its WARP controller process and network link connection 238 and 240 which connects to edge router 236 which connects to edge router 212 using network link connections 232 and 234. Edge router 212 connects to NRMP 230 using network link connections 226 and 228.

Prior to real-time traffic processing, a WARP has to establish its TE-RSVP trunk routes. In FIG. 2, the trunk table for WARP 218 is data filled by entering the information using PC 260 and Command Line Interface 256, or it receives the data from the control process in NRMP 230 using the Trivial File Transfer Protocol (TFTP) to transfer the information using link connections 214 and 216 that connect to edge router 212. Edge router 212 sends to and receives TFTP packets from NRMP 230 using link connections 226 and 228.

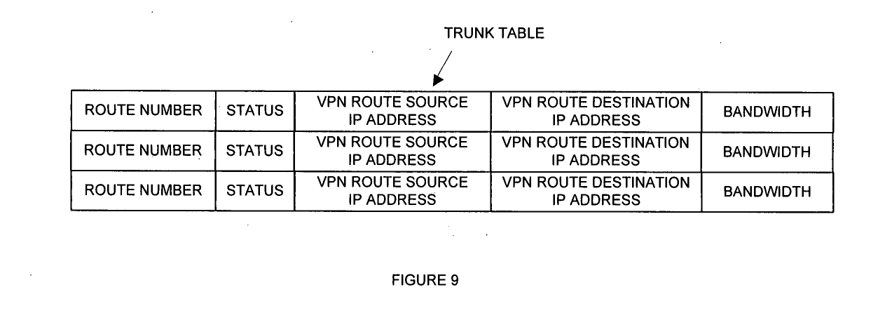

FIG. 9 illustrates the trunk table information.

| | |
|---|---|
| route number | The Unique numeric value assigned to this route |
| | “route number zero is reserved for local traffic |
| | use” |
| Status | Active trunk, Idle trunk, Out Of Service |
| VPN route Source IP | TCP/IP Source address used for this route |
| address | |
| VPN route Destination | TCP/IP Destination address used for this route |
| address | |
| Bandwidth | Amount of bandwidth to reserve for this route |

The WARP initializes the trunk route using TE-RSVP IP protocol to reserve the path and obtain a guarantee from the network for the required bandwidth. A trunk marked “Active” will be used to pass real-time traffic between two WARPs. A trunk marked “Idle” will only send traces and pings to monitor the status of the path. trunks marked “Out of Service” will stop the monitoring process and attempt to clear the TE-RSVP reservation from the network if it had been implemented prior to its status changing.

VPN route number zero is used for local traffic. Local traffic are sessions that occur between two IP devices that are serviced by the same edge router and WARP. For route number zero, pings and trace route commands are sent to the adjacent edge router ports that connect the WARP to the network.

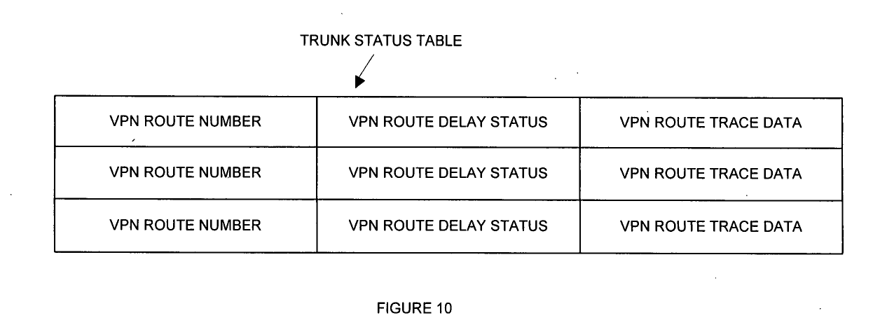

FIG. 10 illustrates the trunk status table maintained in the WARP.

| | |
|---|---|
| VPN route number | The Unique numeric value assigned to this route |
| VPN route Delay | Delay between last two packets, Last ping data |
| Status | and timestamp |
| VPN route Trace | Last Trace data received for this route and |
| Data | timestamp |

When the NRMP 230 in FIG. 2 requests “trunk status”, the WARP receiving the request will send the information in FIG. 9 trunk table and FIG. 10 trunk status table for all its trunks.

Before an IP device can make VoIP calls using a soft switch redirect server, it must go through a registration process. This process is used to identify the IP device to the soft switch and register an IP address for the IP device, so other IP devices can obtain and use the IP address to exchange packets with the IP device.

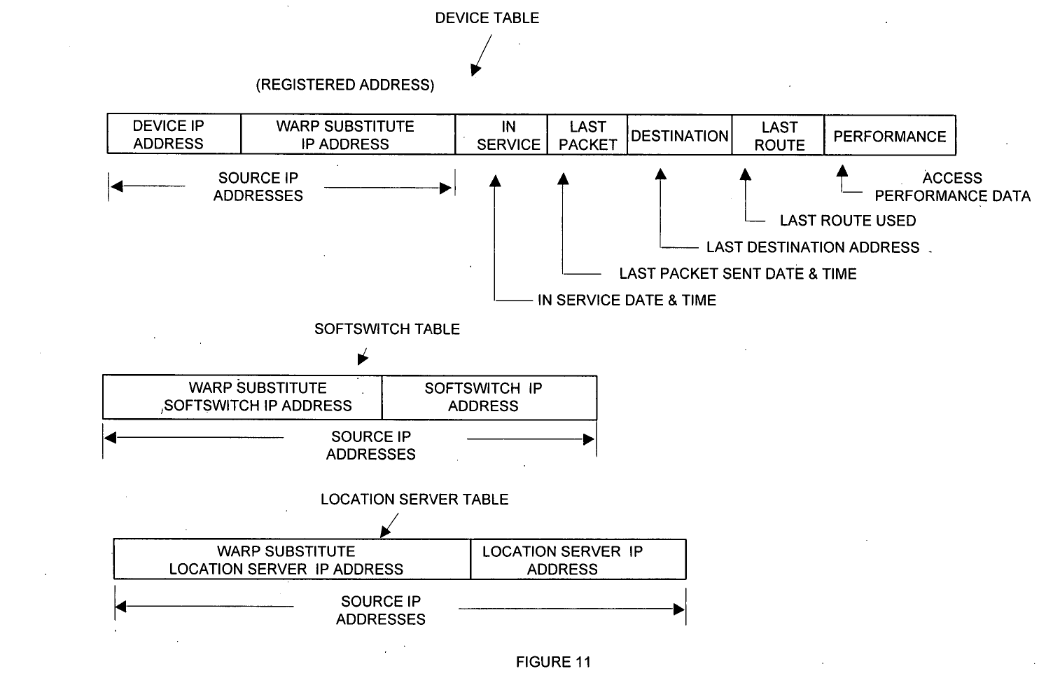

In FIG. 2, IP device 200 sends a packet over connection 202 which connects to access router 206. The packet contains an IP registration message and is addressed to the substitute soft switch IP address for soft switch 224 which is found the soft switch table of FIG. 11. Access router 206 examines the TCP/IP header for the destination address and routes the packet using connection 208 which connects to edge router 212. Edge router 212 examines the TCP/IP header destination address and routes it to WARP 218 using connection 214.

WARP 218 determines a soft switch IP address in the soft switch table of FIG. 11 that matches the substitute soft switch address in the packet, and determines that the packet contains an IP registration message. WARP 218 uses the source IP address in the TCP/IP header to look for an entry for that IP device in the FIG. 11 device table. If it finds an entry, it proceeds to “Route the Packet” below.

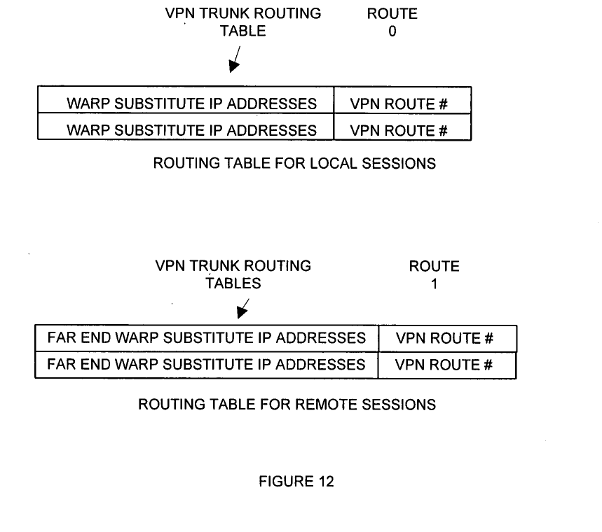

If WARP 218 does not find a matching entry in the device table of FIG. 11, WARP 218 creates a new entry in the device table. WARP 218 assigns a substitute IP address to IP device 200. WARP 218 saves the assigned substitute IP address in the device table WARP substitute IP address field. WARP 218 saves the IP address for IP device 200 in the device IP address field. WARP 218 adds this substitute IP address to VPN trunk routing table zero in FIG. 12.

Route the Packet—WARP 218 changes the TCP/IP header source address from the IP address for IP device 200 to the substitute IP address for IP device 200 that it obtains from the device table of FIG. 11. Next, WARP 218 replaces the destination address in the header from the substitute soft switch IP address to the actual soft switch IP address that it obtains from the soft switch table in FIG. 11. WARP 218 then routes the IP registration message packet using connection 216 which connects to edge router 212. Edge router 212 examines the TCP/IP header for the destination address and routes the packet using connection 220 which connects to soft switch 224.

Soft switch 224 receives and processes the IP registration message, and in response, sends a packet containing a response message to the substitute IP address for IP device 200 using connection 222 which connects to edge router 212. Edge router 212 examines the TCP/IP header for the destination address and routes the packet using connection 214 which connects to WARP 218.

WARP 218 examines the TCP/IP header for the source address and determines that it is the soft switch IP address. If the response packet is for a registration message, WARP 218 stores the current date and time in the device table in-service field in FIG. 11 for IP device 100. WARP 218 changes the TCP/IP header destination field that contains the substitute IP address to the IP address for IP device 200 that it obtains from the device table in FIG. 11. WARP 218 changes the TCP/IP header source field address to the substitute soft switch IP address for soft switch 224 that it obtains from soft switch table in FIG. 11.

WARP 218 then sends the packet containing the response using connection 216 which connects to edge router 212. Edge router 212 examines the TCP/IP header for the destination address and sends the packet using connection 210 which connects to access router 206. Access router 206 examines the TCP/IP header for the destination address and sends the packet using connection 204 which connects to IP device 200.

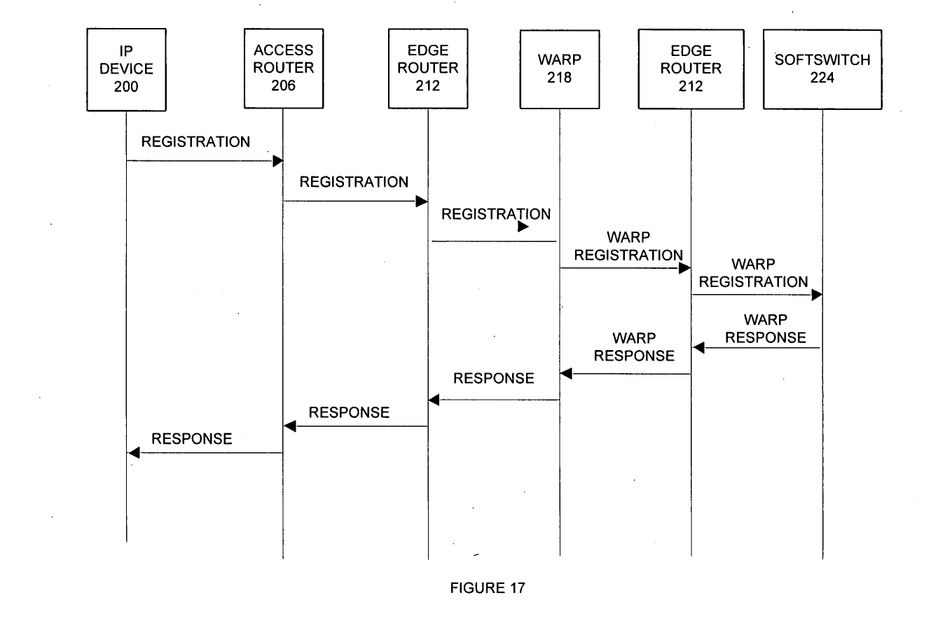

When this exchange of IP registration messages is complete, IP device 200 is ready to make VoIP calls. FIG. 17 illustrates this registration process. The same registration process must also take place between IP device 254, WARP 242, and soft switch 224 before the IP devices 200 and 254 can communicate with each other.

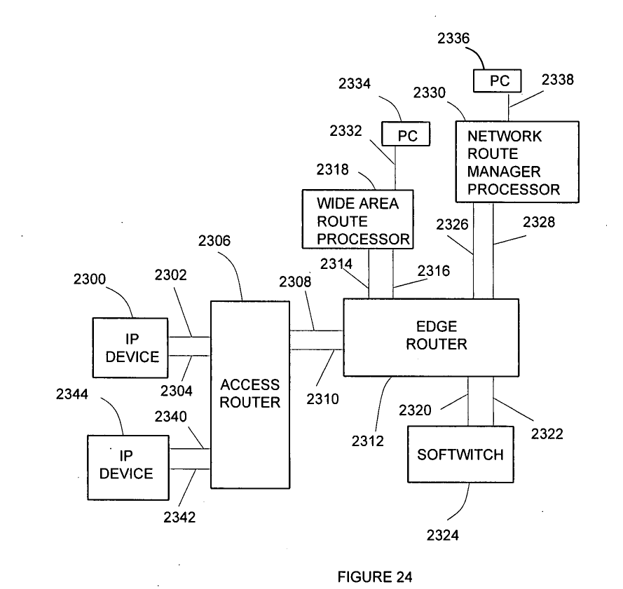

The same IP registration process that applies to IP devices 200 and 254 applies to IP device 2300 and 2344 in FIG. 24

The following example describes how signaling packets are sent between the two IP devices that are connected to the network by different edge routers and that are serviced by different WARPs.

IP device 200 sends a packet that contains a connect message for IP device 254 to the substitute soft switch IP address for soft switch 224 using connection 202 which connects to access router 206. Access router 206 examines the TCP/IP header for the destination address and routes the packet using connection 208 which connects to edge router 212. Edge router 212 examines the TCP/IP header destination address and routes the packet to WARP 218 using connection 214.

WARP 218 examines the destination IP address and when it matches the substitute soft switch IP address in the soft switch table of FIG. 11, and the packet does not contain and IP registration message, WARP 218 changes the TCP/IP header source address from the IP address for IP device 200 to the substitute IP address for IP device 200 that is obtained from the device table of FIG. 11. WARP 218 replaces the destination address in the header from the substitute soft switch IP address for soft switch 224 to the actual IP address of soft switch 224 that it obtains from the soft switch table in FIG. 11. WARP 218 then routes the connect message packet using connection 216 which connects to edge router 212. Edge router 212 examines the TCP/IP header for the destination address and routes the packet using connection 220 which connects to soft switch 224.

Soft switch 224 receives the connect message packet, processes the connection request, and sends a packet back to the substitute IP address for IP device 200. The packet contains a response message that contains the substitute IP address for IP device 254 (this substitute address was provided to soft switch 224 by WARP 242 during the registration for IP device 254). Soft switch 224 sends the response message using connection 222 which connects to edge router 212. Edge router 212 examines the TCP/IP header for the destination address and routes the packet using connection 214 which connects to WARP 218.

WARP 218 examines the TCP/IP header for the source address and sees that it is the soft switch IP address. WARP 218 changes the TCP/IP header destination field that contains the substitute IP address for IP device 200 to the real IP address for IP device 200 which it obtains from the device table in FIG. 11. WARP 218 changes the TCP/IP header source field address to the substitute soft switch IP address for soft switch 224 which it obtains from soft switch table in FIG. 11.

WARP 218 then sends the packet containing the response using connection 216 which connects to edge router 212. Edge router 212 examines the TCP/IP header for the destination address and sends the packet using connection 210 which connects to access router 206. Access router 206 examines the TCP/IP header for the destination address and sends the packet using connection 204 which connects to IP device 200.

When this exchange of connect messages completes, the IP device 200 may use the substitute IP address for IP device 254 to place VoIP calls.

IP device 200 sends a packet that contains a connect message using the substitute IP address for IP device 254 that it received in the connect response message. IP device 200 sends the connect message using connection 202 which connects to access router 206. Access router 206 examines the TCP/IP for the destination address and routes the packet using connection 208 which connects to edge router 212. Edge router 212 examines the TCP/IP header destination address and routes the packet to WARP 218 using connection 214.

WARP 218 locates the source IP address in the packet and uses the device table in FIG. 11 to obtain the substitute IP address for IP device 200. It obtains the destination IP address in the TCP/IP header and matches it to a far-end substitute IP address for IP device 254 in the VPN trunk routing tables in FIG. 12. If it finds there isn't a match, WARP 218 discards the packet and the originators of the message must timeout and resend the message.

If there is a match, WARP 218 uses the VPN route # field entry of the device table in FIG. 12 to route the packet. In this example, we use VPN route 1. WARP 218 changes the TCP/IP header source address from the IP address of IP device 200 to the substitute IP address for IP device 200 that it obtains from the device table in FIG. 11. WARP 218 then sends the connect message packet to the trunk message process that is indicated by the VPN route #.

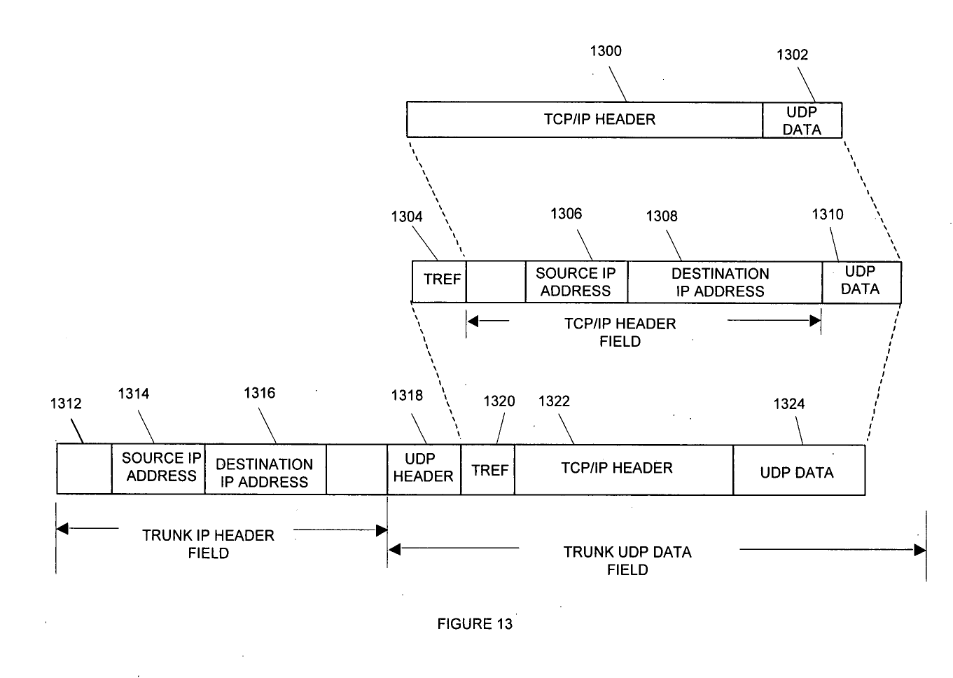

When the VPN route # is other than VPN route zero (VPN route zero processing is described in the local connect request example), WARP trunk message processing for VPN routes 1-N is used. WARP trunk message processing for VPN routes 1-N is illustrated in FIG. 13, where 1300 is the TCP/IP header that was received and 1302 is the UDP data field of that message. The TCP/IP header is modified before the packet is encapsulated in the data field of the VPN trunk packet. The TCP/IP source 1306 address is changed as described above. A time stamp field TRef 1304 is appended to the front of the message. UDP data 1302 is retained as UDP data 1310 unchanged from when it was received. This new trunk message is then queued to the trunk transmit queue as a block of UDP data to send to the VPN route. The “to trunk message TX queue” process builds the TCP/IP header and UDP header for the message and places it into the trunk transmit message queue.

WARP 218 sends the queued packet to edge router 212 using connection 216. Edge router 212 examines the TCP/IP header for the destination address and routes the packet using connection 232 and VPN TE-RSVP route 1 which connects to edge router 236. Edge router 236 examines the TCP/IP header for the destination address and routes the packet using connection 238 which connects to WARP 242.

WARP 242 examines the message received by its trunk message process and strips the TCP/IP and UDP header then removes and stores the TRef time stamp information. The original TCP/IP header and data field can now be processed.

Using the destination address in the TCP/IP header (the substitute IP address for IP device 254) WARP 242 finds the actual IP address for IP device 254 in the device table of FIG. 11 and modifies the TCP/IP header destination field with it.

WARP 242 sends the message to the send to device queue where the packet is sent to edge router 236 using connection 240. Edge router 236 examines the TCP/IP header for the destination address and sends the packet using connection 244 which connects to access router 248. Access router 248 examines the TCP/IP header for the destination address and routes the packet using connection 250 which connects to IP device 254.

IP device 254 processes the connection request message and sends a packet containing a response message that indicates either an acceptance or rejection of the call to the substitute IP address for IP device 200 using connection 252 which connects to access router 248. Access router 248 examines the TCP/IP header for the destination address and routes the packet using connection 246 which connects to edge router 236. Edge router 236 examines the TCP/IP header for the destination address and routes the packet using connection 238 which connects to WARP 242.

WARP 242 locates the source IP address in the packet and uses the device table in FIG. 11 to obtain the substitute IP address for IP device 254. WARP 242 obtains the destination IP address in the TCP/IP header and matches it to the WARP substitute IP address for IP device 200 in the VPN trunk routing tables in FIG. 12. If it finds there isn't a match, WARP 242 discards the packet and the originators of the message must timeout and resend the message.

If there is a match, WARP 242 uses the VPN route # field entry of device table in FIG. 11 to route the packet. In this example, we used VPN route 1. WARP 242 changes the TCP/IP header source address from the IP address of IP device 254 to the substitute IP address for IP device 254 that it obtains from the device table in FIG. 11. WARP 242 then sends the connect message packet to the trunk message process that is indicated by the VPN route #.

When the VPN route # is other than VPN route zero (VPN route zero processing is described in the local connect request example), WARP trunk message processing for VPN routes 1-N is used. WARP trunk message processing for VPN routes 1-N is illustrated in FIG. 13, where 1300 is the TCP/IP header that was received and 1302 is the UDP data field of that message. The TCP/IP header is modified before the packet is encapsulated in the data field of the VPN trunk packet. The TCP/IP source 1306 address is changed as described above. A time stamp field TRef 1304 is appended to the front of the message. UDP data 1302 is retained as UDP data 1310 unchanged from when it was received. This new trunk message is then queued to the trunk transmit queue as a block of UDP data to send to the VPN route. The “to trunk message TX queue” process builds the TCP/IP header and UDP header for the message and places it into the trunk transmit message queue.

WARP 242 sends the queued packet to edge router 236 using connection 240. Edge router 236 examines the TCP/IP header for the destination address and routes the packet using connection 234 and VPN TE-RSVP route 1 which connects to edge router 212. Edge router 212 examines the TCP/IP header for the destination address and routes the packet using connection 216 which connects to WARP 218.

WARP 218 examines the message received by its trunk message process and strips the TCP/IP and UDP header then removes and stores the TRef time stamp information. The original TCP/IP header and data field now can be processed.

Using the substitute IP address for IP device 200 in the destination address of the TCP/IP header, WARP 218 finds the IP address for IP device 200 in the device table of FIG. 11 and modifies the TCP/IP header destination field with it.

WARP 218 sends the message to the send to device queue where the packet is sent to edge router 212 using connection 216. Edge router 212 examines the TCP/IP header for the destination address and routes the packet using connection 210 which connects to access router 206. Access router 206 examines the TCP/IP header for the destination address and routes the packet using connection 204 which connects to IP device 200.

When IP devices 200 and 254 complete their exchange of signaling messages they can begin to send real-time data packets to each other. IP device 200 sends a packet that contains RTP data using the far end substitute IP address for IP device 254 that it received in the connect response message. IP device 200 sends the RTP data message using connection 202 which connects to access router 206. Access router 206 examines the TCP/IP for the destination address and routes the packet using connection 208 which connects to edge router 212. Edge router 212 examines the TCP/IP header destination address and routes the packet to WARP 218 using connection 214.

WARP 218 obtains the substitute IP address for IP device 100 using the source IP address from the packet and the device table in FIG. 11. WARP 218 matches the destination IP address in the TCP/IP header with a far end substitute IP address in the VPN trunk routing tables in FIG. 12.

If it finds there isn't a match, WARP 218 discards the packet and the originators of the message must timeout and resend the message.

If there is a match, WARP 218 uses the VPN route # field entry of the device table in FIG. 11 to route the packet. In this example, we use VPN route 1. WARP 218 changes the TCP/IP header source address from the IP address of IP device 100 to the substitute IP address for IP device 100 that it obtains from the device table in FIG. 11. WARP 218 then sends the RTP data packet to the trunk message process that is indicated by the VPN route #.

When the VPN route # is other than VPN route zero (VPN route zero processing is described in the local connect request example), WARP trunk message processing for VPN routes 1-N is used. WARP trunk message processing for VPN routes 1-N is illustrated in FIG. 13 where 1300 is the TCP/IP header that was received and 1302 the UDP data field of that message. The TCP/IP header is modified before the packet is encapsulated in the data field of the VPN trunk packet. The TCP/IP source 1306 address is changed as described above. A time stamp field TRef 1304 is appended to the front of the message. UDP data 1302 is retained as UDP data 1310 unchanged from when it was received. This new trunk message is then queued to the trunk transmit queue as a block of UDP data to send to the VPN route. The “to trunk message TX queue” process builds the TCP/IP header and UDP header for the message and places it into the trunk transmit message queue.

WARP 218 sends the queued packet to edge router 212 using connection 216. Edge router 212 examines the TCP/IP header for the destination address and routes the packet using connection 232 and VPN TE-RSVP route 1 which connects to edge router 236. Edge router 236 examines the TCP/IP header for the destination address and routes the packet using connection 238 which connects to WARP 242.

WARP 242 examines the message received by its trunk message process and strips the TCP/IP and UDP header then removes and stores the TRef time stamp information. The original TCP/IP header and data field now can be processed.

Using the substitute IP address in the destination address of the TCP/IP header, WARP 242 finds the IP address for IP device 254 in the device table of FIG. 11 and modifies the TCP/IP header destination field with it.

WARP 242 sends the message to the send to device queue where the packet is sent to edge router 236 using connection 240. Edge router 236 examines the TCP/IP header for the destination address and sends the packet using connection 244 which connects to access router 248. Access router 248 examines the TCP/IP header for the destination address and routes the packet using connection 250 which connects to IP device 254.

IP device 254 sends a packet that contains an RTP data for IP device 200 to remote WARP 200 using the far end substitute IP address for IP device 200 that it previously received in the connect message sent by IP device 200. IP device 254 sends the RTP data message using connection 252 which connects to access router 248. Access router 248 examines the TCP/IP for the destination address and routes the packet using connection 246 which connects to edge router 236. Edge router 236 examines the TCP/IP header destination address and routes the packet to WARP 242 using connection 238.

WARP 242 locates the source IP address entry using the device table in FIG. 11 and obtains the substitute IP address for IP device 254. WARP 242 obtains the destination IP address in the TCP/IP header and matches it to a far end substitute IP address in the VPN trunk routing tables in FIG. 12.

If it finds there isn't a match, WARP 242 discards the packet and the originators of the message must timeout and resend the message.

If there is a match, WARP 242 uses the VPN route # field entry of device table in FIG. 11 to route the packet. In this example we used VPN route 1. It changes the TCP/IP header source address from the actual IP address for IP device 254 to the substitute IP address for IP device 254 that it obtains from the device table in FIG. 11. WARP 242 then sends the data message packet to the trunk message process that is indicated by the VPN route #.

When the VPN route # is other than VPN route zero (VPN route zero processing is described in the local session example) WARP trunk message processing for VPN routes 1-N is used. WARP trunk message processing for VPN routes 1-N is illustrated in FIG. 13 where 1300 is the TCP/IP header that was received and 1302 the UDP data field of that message. The TCP/IP header is modified before the packet is encapsulated in the data field of the VPN trunk packet. The TCP/IP source 1306 and TCP/IP destination 1308 addresses are changed as described above. A time stamp field TRef 1304 is appended to the front of the message. UDP data 1302 is retained as UDP data 1310 unchanged from when it was received. This new trunk message is then queued to the trunk transmit queue as a block of UDP data to send to the VPN route. The “to trunk message TX queue” process builds the TCP/IP header and UDP header for the message and places it into the trunk transmit message queue.

WARP 242 sends the queued packet to edge router 236 using connection 240. Edge router 236 examines the TCP/IP header for the destination address and routes the packet using connection 234 and VPN TE-RSVP route 1 which connects to edge router 212. Edge router 212 examines the TCP/IP header for the destination address and routes the packet using connection 214 which connects to WARP 218.

WARP 218 examines the message received by its trunk message process and strips the TCP/IP and UDP header then removes and stores the TRef time stamp information. The original TCP/IP header and data field now can be processed.

Using the destination substitute IP address in the TCP/IP header WARP 218 finds the device IP address in the device table in FIG. 11 and modifies the TCP/IP header destination field with it.

WARP 218 sends the message to the send to device queue where the packet is sent to edge router 212 using connection 216. Edge router 212 examines the TCP/IP header for the destination address and routes the packet using connection 210 which connects to access router 206. Access router 206 examines the TCP/IP header for the destination address and routes the packet using connection 204 which connects to IP device 200.

When a WARP changes a TCP/IP address, it should also change the TCP/IP checksum correspondingly.

FIGS. 17-22 illustrate the message and real-time data flows discussed above.

The IP registration process requirement that applied to IP devices 200 and 254 applies also to IP device 2300 and 2344 in FIG. 24. The following example describes how signaling packets are sent between the two IP devices that are connected to the network by the same edge routers and serviced by the same WARPs.

In FIG. 24, IP device 2300 sends a packet that contains a connect message to the WARP 2318's substitute soft switch 2324 IP address using connection 2302 which connects to access router 2306. Access router 2306 examines the TCP/IP header for the destination address and routes the packet using connection 2308 which connects to edge router 2312. Edge router 2312 examines the TCP/IP header destination address and routes the packet to WARP 2318 using connection 2314.

WARP 2318 examines the destination IP address and when it matches the substitute soft switch address in the soft switch table in FIG. 11 and the packet doesn't contain and IP registration message, it changes the TCP/IP header source address from the IP device's IP address to its substitute IP address obtained from the device table in FIG. 11. WARP 2318 replaces the destination address in the header from the substitute soft switch IP address to the soft switch IP address it obtains from the soft switch table in FIG. 11. WARP 2318 then routes the connect message packet using connection 2316 which connects to edge router 2312. Edge router 2312 examines the TCP/IP header for the destination address and routes the packet using connection 2320 which connects to soft switch 2324

Soft switch 2324 receives the connect message packet, processes the connection request, and sends a packet containing its response message that contains IP device 2344's IP address in the response message sent back to IP device 2300's substitute IP address. Soft switch 2324 sends the response message using connection 2322 which connects to edge router 2312. Edge router 2312 examines the TCP/IP for the destination address and routes the packet using connection 2314 which connects to WARP 2318.

WARP 2318 examines the TCP/IP header for the source address and sees that it is the soft switch IP address. It changes the TCP/IP header destination field that contains the substitute IP address to the real IP device IP address it obtains from the device table in FIG. 11. It changes the TCP/IP header source field address to the substitute soft switch IP address it obtains from soft switch table in FIG. 11.

WARP 2318 then sends the packet containing the response using connection 2316 which connects to edge router 2312. Edge router 2312 examines the TCP/IP header for the destination address and sends the packet using connection 2310 which connects to access router 2306. Access router 2306 examines the TCP/IP header for the destination address and sends the packet using connection 2304 which connects to IP device 2300.

When this exchange of connect messages is complete, IP device 2300 uses the IP address it received in the response message to place the VoIP call.

IP device 2300 sends a packet that contains a connect message to remote WARP 2344 using the far end substitute IP address it previously received from WARP 2318 in the connect response message sent to it by soft switch 2324. IP device 2300 sends the connect message using connection 2302 which connects to access router 2306. Access router 2306 examines the TCP/IP header for the destination address and routes the packet using connection 2308 which connects to edge router 2312. Edge router 2312 examines the TCP/IP header destination address and routes the packet to WARP 2318 using connection 2314.

WARP 2318 uses the device table in FIG. 11 to locate the source IP address entry and obtain its substitute IP address. It obtains the destination IP address in the TCP/IP header and matches it to a far end substitute IP address in the VPN trunk routing tables in FIG. 12.

If it finds there isn't a match, WARP 2318 discards the packet and the originators of the message must timeout and resend the message.

If there is a match WARP 2318 uses the VPN route # field entry of the device table in FIG. 11 to route the packet. In this example we use VPN route 0. When the VPN route equals zero, WARP 2318 changes the TCP/IP header source address from the IP device's IP address to the substitute IP address that it obtains from the device table in FIG. 11. WARP 2318 obtains the destination IP address from the TCP/IP header and searches the device table in FIG. 11 and matches it to an entry in this table. WARP 2318 obtains the IP address from the device IP address field of that entry. WARP 2318 puts this IP device address in the TCP/IP header destination field. WARP 2318 then sends the connect message packet to the trunk message process that is indicated by the VPN route #.

When the VPN route # is VPN route zero, WARP 2318 uses the to device queue to send the packet to edge router 2312 using connection 2316. Edge router 2312 examines the TCP/IP header for the destination address and routes the packet using connection 2310 which connects to access router 2306. Access router 2306 examines the TCP/IP header for the destination address and routes the packet using connection 2342 which connects to IP device 2344.

IP device 2344 processes the connection request message and sends a packet containing a response message that indicates either an acceptance or rejection of the call to IP device 2300's substitute IP address using connection 2340 which connects to access router 2406. Access router 2306 examines the TCP/IP header for the destination address and routes the packet using connection 2308 which connects to edge router 2312. Edge router 2312 examines the TCP/IP header for the destination address and routes the packet using connection 2314 which connects to WARP 2318.

WARP 2318 uses the device table in FIG. 11 to obtain the source IP address and obtain its substitute IP address.

WARP 2318 uses the device table in FIG. 11 to locate the source IP address entry and obtains its substitute IP address. WARP 2318 obtains the destination IP address in the TCP/IP header and matches it to a far end substitute IP address in the VPN trunk routing tables in FIG. 12.

If it finds there isn't a match, WARP 2318 discards the packet and the originators of the message must timeout and resend the message.

If there is a match, WARP 2318 uses the VPN route # field entry of device table in FIG. 11 to route the packet. In this example we use VPN route 0. When the VPN route equals zero, WARP 2318 changes the TCP/IP header source address from the IP device's IP address to the substitute IP address that it obtains from the device table in FIG. 11. WARP 2318 obtains the destination IP address from the TCP/IP header and searches the device table in FIG. 11 and matches it to an entry in this table. WARP 2318 obtains the IP address from the device IP address field of that entry. WARP 2318 puts this IP device address in the TCP/IP header destination field. WARP 2318 then sends the connect message packet to the trunk message process that is indicated by the VPN route #.

When the VPN route # is VPN route zero, WARP 2318 uses the to device queue to send the packet to edge router 2312 using connection 2316 edge router 2312 examines the TCP/IP header for the destination address and routes the packet using connection 2310 which connects to access router 2306. Access router 2306 examines the TCP/IP header for the destination address and routes the packet using connection 2304 which connects to IP device 2300.

When IP device 2300 and 2344 complete their exchange of signaling messages they can begin to send real-time data packets to each other.

IP device 2300 sends a packet that contains RTP data to remote WARP 2344 using the far end substitute IP address it previously received in the connect response message sent by soft switch 2324. IP device 2300 sends the connect message using connection 2302 which connects to access router 2306. Access router 2306 examines the TCP/IP for the destination address and routes the packet using connection 2308 which connects to edge router 2312. Edge router 2312 examines the TCP/IP header destination address and routes the packet to WARP 2318 using connection 2314.

WARP 2318 uses the device table in FIG. 11 to locate the source IP address entry and obtain its substitute IP address. WARP 2318 obtains the destination IP address in the TCP/IP header and matches it to a far end substitute IP address in the VPN trunk routing tables in FIG. 12.

If it finds there isn't a match, WARP 2318 discards the packet and the originators of the message must timeout and resend the message.

If there is a match, WARP 2318 uses the VPN route # field entry of device table in FIG. 11 to route the packet. In this example we use VPN route 0. When the VPN route equals zero, WARP 2318 changes the TCP/IP header source address from the IP device's IP address to the substitute IP address that it obtains from the device table in FIG. 11. WARP 2318 obtains the destination IP address from the TCP/IP header and searches the device table in FIG. 11 and matches it to an entry in this table. WARP 2318 obtains the IP address from the device IP address field of that entry. WARP 2318 puts this IP device address in the TCP/IP header destination field. WARP 2318 then sends the RTP data message packet to the trunk message process that is indicated by the VPN route #.

When the VPN route # is VPN route zero, WARP 2318 uses the to device queue to send the packet to edge router 2312 using connection 2316. Edge router 2312 examines the TCP/IP header for the destination address and routes the packet using connection 2310 which connects to access router 2306. Access router 2306 examines the TCP/IP header for the destination address and routes the packet using connection 2342 which connects to IP device 2344.

IP device 2344 sends a packet that contains RTP data to remote WARP 2300 using the far end substitute IP address it previously received in the connect message sent by IP device 2300.

IP device 2344 sends a packet containing RTP data to IP device 2300's substitute IP address using connection 2340 which connects to access router 2406. Access router 2306 examines the TCP/IP header for the destination address and routes the packet using connection 2308 which connects to edge router 2312. Edge router 2312 examines the TCP/IP header for the destination address and routes the packet using connection 2314 which connects to WARP 2318.

WARP 2318 uses the device table in FIG. 11 to obtain the source IP address and obtains its substitute IP address.

WARP 2318 uses the device table in FIG. 11 to locate the source IP address entry and obtain its substitute IP address. WARP 2318 obtains the destination IP address in the TCP/IP header and matches it to a far end substitute IP address in the VPN trunk routing tables in FIG. 12.

If it finds there isn't a match, WARP 2318 discards the packet and the originators of the message must timeout and resend the message.

If there is a match, WARP 2318 uses the VPN route # field entry of device table in FIG. 11 to route the packet. In this example we use VPN route 0. When the VPN route equals zero, WARP 2318 changes the TCP/IP header source address from the IP device's IP address to the substitute IP address that it obtains from the device table in FIG. 11. WARP 2318 obtains the destination IP address from the TCP/IP header and searches the device table in FIG. 11 and matches it to an entry in this table. WARP 2318 obtains the IP address from the device IP address field of that entry. WARP 2318 puts this IP device address in the TCP/IP header destination field. WARP 2318 then sends the RTP data packet to the trunk message process that is indicated by the VPN route #.

When the VPN route # is VPN route zero, WARP 2318 uses the to device queue to send the packet to edge router 2312 using connection 2316. Edge router 2312 examines the TCP/IP header for the destination address and routes the packet using connection 2310 which connects to access router 2306. Access router 2306 examines the TCP/IP header for the destination address and routes the packet using connection 2304 which connects to IP device 2300.

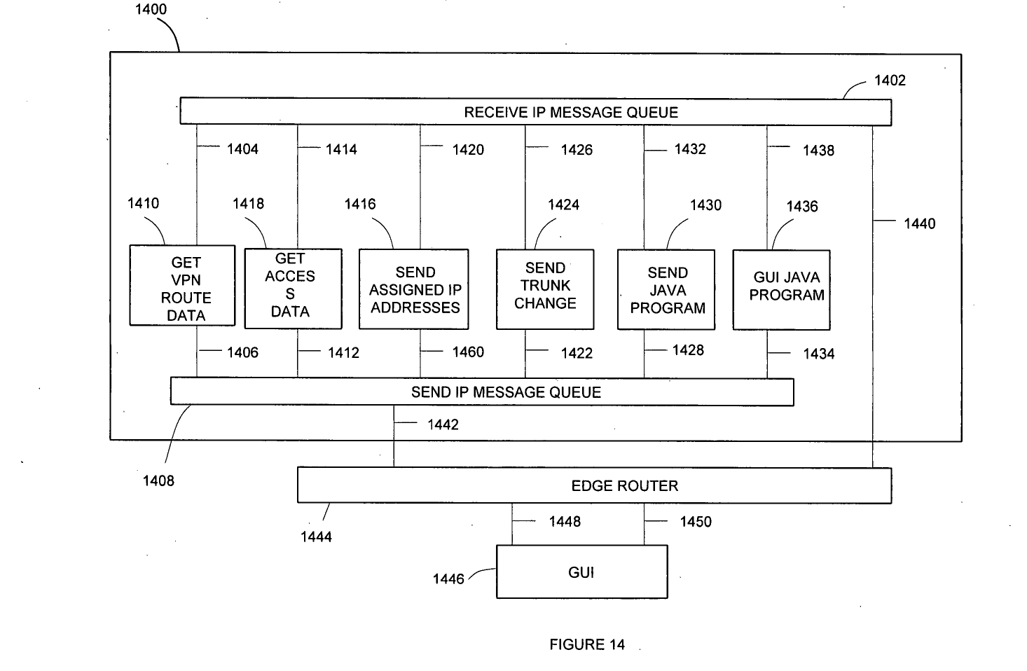

FIG. 14 depicts NRMP 1400 and its major software modules. GUI 1446 is a PC application that communicates with the GUI JAVA PGM 1436 module in NRMP 1400. GUI 1446 will login by sending a packet with the NRMP 1400 address in the destination field that contains login information using connection 1448 that connects to edge router 1444. Edge router 1444 sends the packet to NRMP 1400 using connection 1440. NRMP 1400 receives IP message queue 1402, interprets the port address, and sends the message to GUI JAVA PGM 1436 for processing using queue 1438. If the login is correct, GUI JAVA PGM 1436 returns a response message back to GUI 1446. GUI JAVA PGM 1436 queues the message using 1434 to the NRMP 1400 send IP message queue 1408 which sends it to edge router 1444 using connection 1442. Edge router 1444 sends the packet to GUI 1446 using connection 1450.

GUI 1446 can now initiate one of five command processes. They are:

| | |
|---|---|
| Get VPN route Data | A request for the VPN route Data stored in a |
| | specific WARP's tables |
| Get access Data | A request for the access Data stored in a |
| | specific WARP's tables. |
| Send Assigned IP | Starts a TFTP file transfer of the specific |
| addresses | WARP's tables and IP address assignments that |
| | are stored in NRMP 1400. |
| Send trunk Change | Sends a request to change to an alternate |
| | route for sending real-time traffic between |
| | two specific WARPs. |
| Send JAVA PGM | Starts a TFTP file transfer of a executable |
| | JAVA program that will run in the background |
| | in a specific WARP. |

A user at the PC running the GUI 1446 application selects a command and enters the data required before sending it to GUI JAVA PGM 1436 using connection 1448 that connects to edge router 1444. Edge router sends the packet to connection 1440 which places it in receive IP message queue 1402 that uses the port number to send the packet to GUI JAVA PGM 1436 using queue 1438. GUI JAVA PGM 1436 screens the data received and if it passes the test it hands the packet to the selected command process using an internal memory queue. The process then requests data from or sends data to the WARP that was selected by the user. The following illustrates the interaction that occurs between the process and the WARP selected and the process and the GUI 1446 application.

Get VPN route data 1410 formats a VPN data request packet and sends it to the WARP using connection 1406 which sends the packet to send IP message queue 1408 that sends it using connection 1442 to edge router 1444 that sends it to the correct route to get to the WARP identified in the destination address in the TCP/IP header.

When the response packet is returned from the WARP it is routed back to edge router 1444. Edge router 1444 sends it using connection 1440 which places it in the receive IP message queue 1402 that uses the port number to send the packet being returned to get VPN route data 1410 using queue 1404. Get VPN route data 1410 then analyzes the data and creates the display VPN routes display data that is sent to the GUI 1446 using connection 1406 that sends it to send IP message queue 1408 that sends it to edge router 1444 using connection 1442. Edge router 1444 sends the packet to connection 1450 that connects to GUI 1446. GUI 1446 displays the data it has obtain from the request on the users screen.

Get access route data 1418 formats an access data request packet and sends it to the WARP using connection 1412 which sends the packet to send IP message queue 1408 that sends it using connection 1442 to edge router 1444 that sends it to the correct route to get to the WARP identified in the destination address in the TCP/IP header.

When the response packet is returned from the WARP it is routed back to edge router 1444. Edge router 1444 sends it using connection 1440 which places it in the receive IP message queue 1402 that uses the port number to send the packet being returned to Get access route data 1418 using queue 1414. Get VPN route data 1418 then analyzes the data and creates the display access routes display data that is sent to the GUI 1446 using connection 1412 that sends it to send IP message queue 1408 that sends it to edge router 1444 using connection 1442. Edge router 1444 sends the packet to connection 1450 that connects to GUI 1446. GUI 1446 displays the data it has obtain from the request on the users screen.

Send assigned IP addresses formats the TFTP data transfer packet and sends them to the WARP using connection 1460 which sends the packet to send IP message queue 1408 that sends it using connection 1442 to edge router 1444 that sends it to the correct route to get to the WARP identified in the destination address in the TCP/IP header.

When the data transfer response packet is returned from the WARP, it is routed back to edge router 1444. Edge router 1444 sends it using connection 1440 which places it in the receive IP message queue 1402 that uses the port number to send the packet being returned to the TFTP process in send assigned IP addresses 1416 using queue 1420. When the TFTP transfer of data completes the send assigned IP addresses process creates the TFTP completion display data that is sent to the GUI 1446 using connection 1460 that sends it to send IP message queue 1408 that sends it to edge router 1444 using connection 1442. Edge router 1444 sends the packet to connection 1450 that connects to GUI 1446. GUI 1446 displays the data it has obtain from the request on the users screen.

Send trunk change data 1424 formats the TFTP data transfer packets and sends them to the WARP using connection 1422 which sends the packet to send IP message queue 1408 that sends it using connection 1442 to edge router 1444 that sends it to the correct route to get to the WARP identified in the destination address in the TCP/IP header.

When the data transfer response packet is returned from the WARP, it is routed back to edge router 1444. Edge router 1444 sends it using connection 1440 which places it in the receive IP message queue 1402 that uses the port number to send the packet being returned to the TFTP process in send trunk change data 1424 using queue 1426. When the TFTP transfer of data completes, the send trunk change process creates the TFTP completion display data that is sent to the GUI 1446 using connection 1422 that sends it to Send IP message queue 1408 that sends it to edge router 1444 using connection 1442. Edge router 1444 sends the packet to connection 1450 that connects to GUI 1446. GUI 1446 displays the data it has obtain from the request on the users screen.

Send JAVA PGM 1430 formats the TFTP data transfer packets and sends them to the WARP using connection 1428 which sends the packet to send IP message queue 1408 that sends it using connection 1442 to edge router 1444 that sends it to the correct route to get to the WARP identified in the destination address in the TCP/IP header.

When the data transfer response packet is returned from the WARP, it is routed back to edge router 1444. Edge router 1444 sends it using connection 1440 which places it in the receive IP message queue 1402 that uses the port number to send the packet being returned to the TFTP process in SEND JAVA PGM 1430 using queue 1432. When the TFTP transfer of data completes the send trunk change process creates the TFTP completion display data that is sent to the GUI 1446 using connection 1418 that sends it to send IP message queue 1408 that sends it to edge router 1444 using connection 1442. Edge router 1444 sends the packet to connection 1450 that connects to GUI 1446. GUI 1446 displays the data it has obtained from the request on the users screen.

The JAVA program(s) sent to the WARP can be written to send data to any IP destination and port number you want, so it can be used for further analysis of how the network routes are performing and can be displayed by that application.

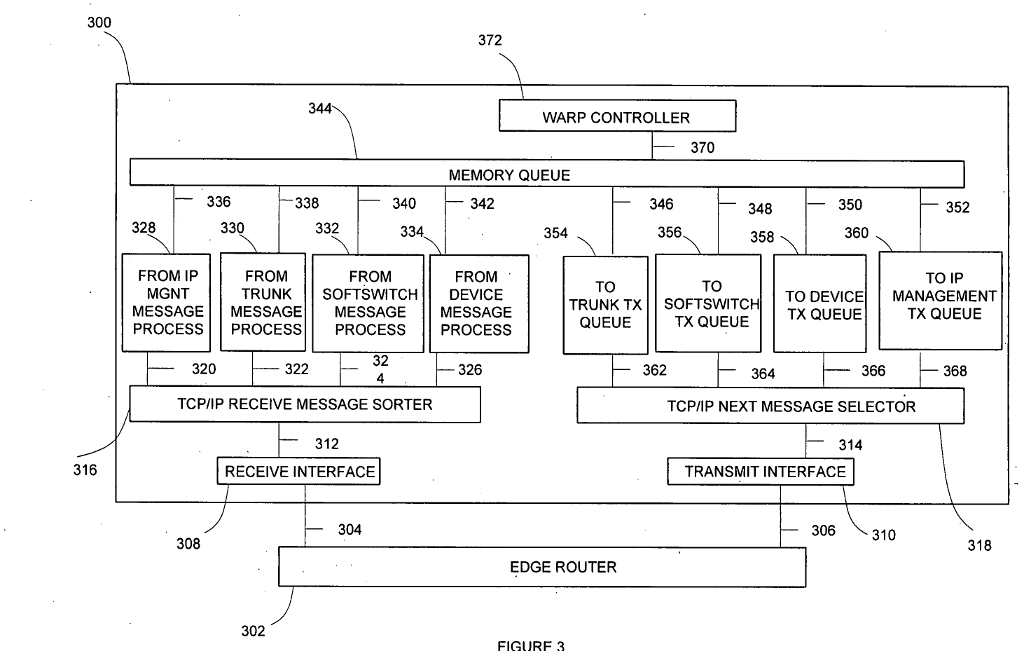

FIG. 3 is a view of the WARP 300 that depicts how the messages it receives and sends are routed internally. Edge router 302 receives a TCP/IP packet that has a destination address that appears to end at the WARP. Edge router 302 sends the packet using link connection 304 to receive interface 308. Receive interface 308 can be any link type that can be used to receive TCP/IP packets. Receive interface 308 checks the message and if it passes the validity test sends it using connection 312 to the TCP/IP receive message sorter 316 that examines the message and sends it to one of four receive processes.
If the source address is a registered device it sends it using queue 326 to the from device message process 334.
If the source address is from the soft switch address in the Soft switch table in FIG. 11 it sends it using queue 324 to the from soft switch message process 332.
If the source address is from one of the WARP's VPN trunks it sends it using queue 322 to the from trunk message process 330.
If the source address is any other IP address it sends it using queue 320 to the from IP management message process 328 to determine what standard network messages it is and how to respond to if (e.g.: route information exchanges).

These four processes also send packets to specific destinations. The messages are first sent over memory bus 344 to the queue that will hold them until they are sent.
From device message process 334 uses connection 342 to transfer packets to memory queue 344.
From soft switch message process 332 uses connection 340 to transfer packets to memory queue 344.
From trunk message process 330 uses connection 338 to transfer packets to memory queue 344.
From IP Management message process 328 uses connection 336 to transfer packets to memory queue 344.
WARP controller 372 uses connection 370 to transfer packets to memory queue 344.
Memory queue 344 uses connection 346 to transfer packets to the to trunk TX queue 354.
Memory queue 344 uses connection 348 to transfer packets to the to soft switch TX queue 356.
Memory queue 344 uses connection 350 to transfer packets to the to device TX queue 358.
Memory queue 344 uses connection 352 to transfer packets to the to IP management TX queue 360.
Memory queue 344 uses connection 370 to transfer packets to the WARP Controller 372

TCP/IP next message selector 318 is used to perform a waited far queuing of the packet to transmit interface 310. Transmit interface 310 can be any link type that can be used to transmit TCP/IP packets.

Packets are sent to transmit interface 310 using TCP/IP next message selector connection 314. Transmit interface 310 sends the packets to edge router 302 using connection 306. Edge router sends the packets to the destination address in the TCP/IP header.

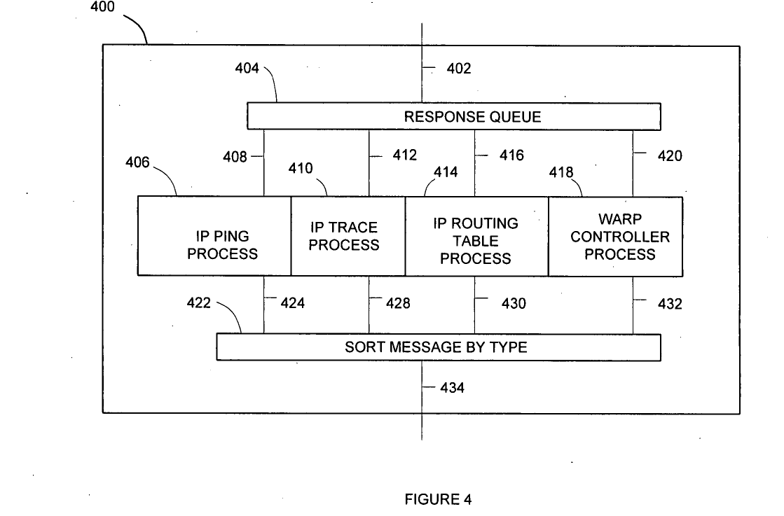

FIG. 4 is another view of the from IP management message process 328 in FIG. 3. When an IP management message process 400 packet is received by the sort message by type 422 process using queue 434. Sort message by type 422 examines the packet and determines which queue to place it in.
message for the IP ping process are put in queue 424
message for the IP trace process are put in queue 428
message for the IP routing table process are put in queue 430
messages for the WARP controller process are put in queue 432
message sent by the ping process are put in queue 408
message sent by the IP trace process are put in queue 412
messages sent by IP routing table process are put in queue 416
message set by the WARP controller process are put in queue 420

In FIG. 4, the response queue process 404 takes messages from queues 408, 412, 416, 420 one at a time in a round robin manner and queues them to the memory queue 344 FIG. 3 using queue 402.

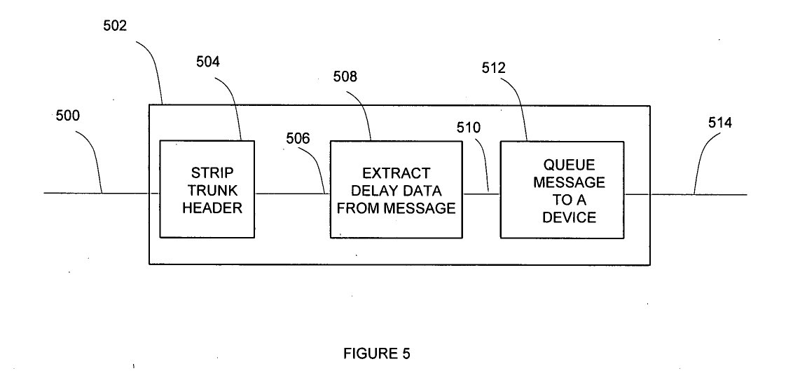

FIG. 5 is another view of the from trunk message process 330 in FIG. 3. Message trunk process 502 in FIG. 5 receives packets from queue 500. Strip trunk header 504 removes the header and UDP header information from the packet and sends the packet to extract delay data from message 508 using queue 506. Next extract delay data from message 508 removes and store the trunk delay information TRef and sends the packet to queue message to a device 512 using queue 510. Queue message to a device 512 changes the source and destination fields in the TCP/IP header and queues the packet to the memory queue 344 of FIG. 3 using queue 514.

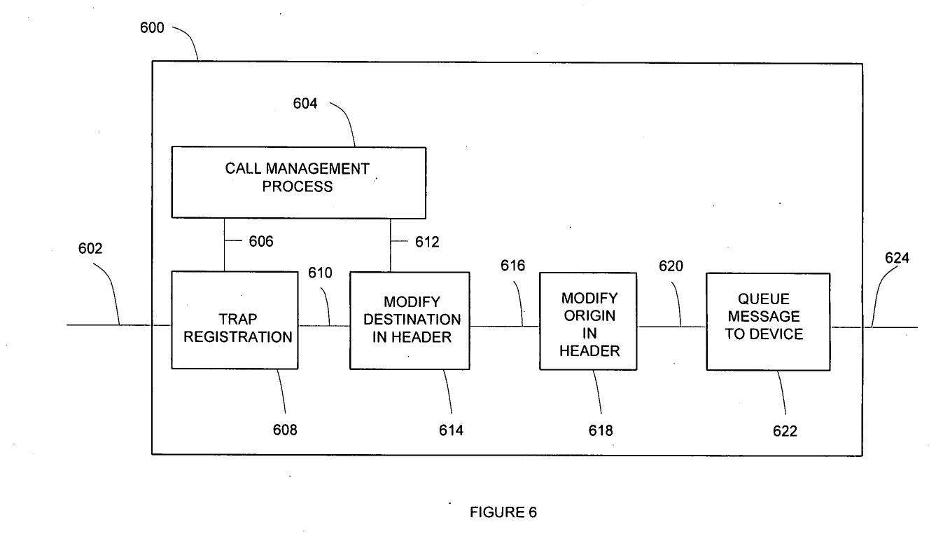

FIG. 6 is another view of the from soft switch message process 332 in FIG. 3. Device message process 600 receives packets from queue 602. Trap 608 examines the packet for the type of signaling message and if it finds a registration response message sends the packet to call management process 604 using queue 606. If the message is not a registration message, it sends the packet to modify destination in header 614 using queue 610. When call management process 604 complete it's task which is to set the device table in service field entry for this IP device in FIG. 11 to the current date and time.

It sends the packet to modify destination in header 614 using queue 612. Modify destination in header 614 changes the TCP/IP header destination to device IP address depending on what the destination address received in the packet header. Next the packet is queued using queue 616 to modify origin in header 618. Modify origin in header 618 changes the source address in the TCP/IP header to the substitute IP address assigned to the soft switch it obtains from the soft switch table in FIG. 11. Modify origin in header 618 queues the packet using queue 620 to queue message 622. Queue message 622 queues the packet to the memory queue 344 in FIG. 3 using queue 624 in FIG. 6.

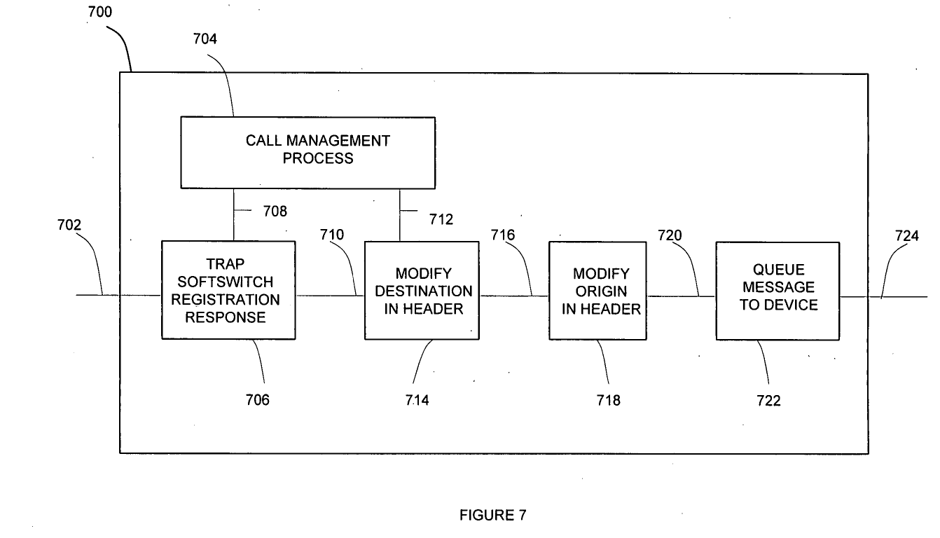

FIG. 7 is another view of the from device message process 334 in FIG. 3. Device message process 700 receives packets from queue 702. Trap 706 examines the packet for the type of signaling message and if the message is not a registration response message it sends the packet to modify destination in header 714 using queue 710.

If it finds a registration message it sends the packet to call management process 704 using queue 708. When call management process 704 completes its task which is to create a device entry in the device table in FIG. 11, it sends the packet to modify destination in header 714 using queue 712.

Modify destination in header 714 changes the TCP/IP header destination based on the VPN route being used. Next the packet is queued using queue 716 to modify origin in header 718. Modify origin in header 718 changes the TCP/IP header source address based on the VPN route being used. Modify origin in header 718 queues the packet using queue 720 to queue message 722. Queue message 722 queues the packet to the memory queue 344 FIG. 3 using queue 724 in FIG. 7.

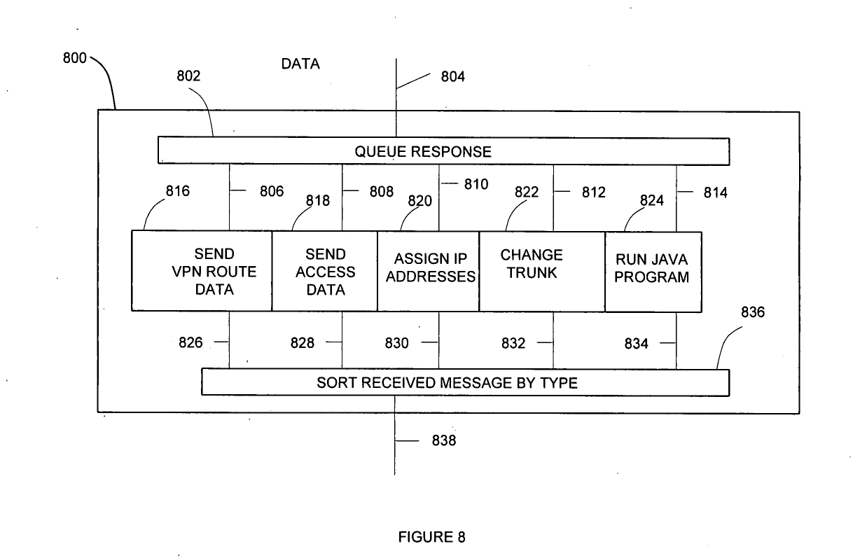

FIG. 8 is another view of the WARP controller 372 in FIG. 3. WARP controller 800 sort receive message by type 836 process receives packets from queue 838. Sort receive message by type 836 examines the packets and queues them to either:
Send VPN route data 816 using queue 826
Send access data 818 using queue 828
Assign IP addresses 820 using queue 830
Change trunk 822 using queue 832
Run JAVA PGM 824 using queue 834

Send VPN route data 816 creates a packet containing the WARP information stored for the specific route requested and send VPN route data 816 sends the packet-using queue 806.

Send access data 818 creates a packet containing the WARP information stored for the specific access device requested and send access data 818 sends the packet-using queue 808.

After completing the TFTP file transfer of IP address assignments, assign IP addresses 820 creates a packet containing an acknowledgment of the completed task and assign IP addresses 820 sends the packet-using queue 810.

After completing the TFTP file transfer of the trunk change data, change trunk 822 creates a packet containing an acknowledgment of the completed task, and change trunk 822 sends the packet-using queue 812.

After completing the TFTP file transfer of the JAVA PGM execution file, run JAVA PGM 824 creates a packet containing the status of the completed task (received and program is running ok, received and program failed to run ok) and run JAVA PGM 824 sends the packet-using queue 814.

Queue response 802 gets the packets from queues 806, 808, 810, 812, and 814 in a round robin manner and sends the packets using 804 to memory queue 344 in FIG. 3 where they are sent to the to IP management TX queue 360 using queue 352. To IP management TX queue 360 hands the packet to TCP/IP next message selector 318 using queue 368.

TCP/IP next message selector 318 is used to perform waited fair queuing of the packet to transmit interface 310. Transmit interface 310 can be any link type that can be used to transmit TCP/IP packets.

Packets are sent to transmit interface 310 using TCP/IP next message selector connection 314. Transmit Interface 310 sends the packets to edge router 302 using connection 306. Edge router sends the packets to the destination address in the TCP/IP header.

1. A method of operating a communication system comprising:
establishing an Internet Protocol (IP) route through an IP system between a first route processor and a second route processor;
in the first route processor, receiving a first registration message from a first user where the first registration message has a first address as a first registration message source address and a second address as a first registration message destination address, processing the first registration message to change the first address to a third address and to change the second address to a fourth address, and transferring the first registration message;
in the second route processor, receiving a second registration message from a second user where the second registration message has a fifth address as a second registration message source address and a sixth address as a second registration message destination address, processing the second registration message to change the fifth address to a seventh address and to change the sixth address to the fourth address, and transferring the second registration message;
in the soft switch, receiving and processing the first registration message to register the first user at the third address and receiving and processing the second registration message to register the second user at the seventh address;
in the first route processor, receiving a first request message from the first user where the request message requests a session with the second user and has the first address as a first request message source address and the second address as a first request message destination address, processing the first request message to change the first address to the third address and to change the second address to the fourth address, and transferring the first request message;
in the soft switch, receiving and processing the first request message to transfer a first response message that associates the second user with the seventh address and has the fourth address as a first response message source address and the third address as a first response message destination address;
in the first route processor, receiving and processing the first response message to change the fourth address to the second address and to change the third address to the first address, and transferring the first response message to the first user;
in the first route processor, receiving a second request message from the first user where the second request message has the first address as a second request message source address and the seventh address as a second request message destination address, processing the second request message to change the first address to the third address, and transferring the second request message;
in the second route processor, receiving and processing the second request message to change the seventh address to the fifth address and transferring the second request message;
in the second route processor, receiving and processing a second response message from the second user where the second response message has the fifth address as a second response message source address and the third address as a second response message destination address, processing the second response message to change the fifth address to the seventh address, and transferring the second response message;
in the first route processor, receiving and processing the second response message to change the third address to the first address, and transferring the second response message;
in the first route processor, receiving a first data message from the first user where the first data message has the first address as a first data message source address and the seventh address as a first data message destination address, processing the first data message to change the first address to the third address, and transferring the first data message over the IP route;
in the second route processor, receiving and processing the first data message to change the seventh address to the fifth address and transferring the first data message;
in the second route processor, receiving and processing a second data message from the second user where the second data message has the fifth address as a second data message source address and the third address as a second data message destination address, processing the second data message to change the fifth address to the seventh address, and transferring the second data message over the IP route;
in the first route processor, receiving and processing the second data message to change the third address to the first address, and transferring the second data message; and
in the first route processor and the second route processor, monitoring performance of the IP route.

2. The method of claim 1 wherein the registration messages, the request messages, and the response messages comprise Session Initiation Protocol messages.

3. The method of claim 1 wherein the registration messages, the request messages, and the response messages comprise H.323 messages.

4. The method of claim 1 wherein the data messages comprise Real-Time Protocol messages.

5. The method of claim 1 wherein the IP route comprises a Resource Reservation Protocol tunnel.

6. The method of claim 1 wherein monitoring the performance of the IP route comprises monitoring packet delay.

7. The method of claim 1 further comprising establishing another IP route through the IP system between the first route processor and the second route processor and using the other IP route for subsequent data transfer between the first route processor and the second route processor based on the monitored performance of the first IP route.

8. The method of claim 1 further comprising transferring information indicating performance of the IP route from the first route processor and the second route processor to a route manager.

9. A method of operating a communication system comprising:
establishing an Internet Protocol (IP) route through an IP system between a first route processor and a second route processor;
in the first route processor, receiving a first data message from a first user where the first data message has a first address as a first data message source address and a seventh address as a first data message destination address, processing the first data message to change the first address to a third address, and transferring the first data message over the IP route;
in the second route processor, receiving and processing the first data message to change the seventh address to a fifth address and transferring the first data message;
in the first route processor and the second route processor, monitoring performance of the IP route.

10. The method of claim 9 further comprising:
in the second route processor, receiving and processing a second data message from the second user where the second data message has the fifth address as a second data message source address and the third address as a second data message destination address, processing the second data message to change the fifth address to the seventh address, and transferring the second data message over the IP route; and
in the first route processor, receiving and processing the second data message to change the third address to the first address, and transferring the second data message.

11. The method of claim 9 further comprising:
in the first route processor, receiving a first registration message from the first user where the first registration message has the first address as a first registration message source address and a second address as a first registration message destination address, processing the first registration message to change the first address to the third address and to change the second address to a fourth address, and transferring the first registration message;
in a soft switch, receiving and processing the first registration message to register the first user at the third address.

12. The method of claim 9 further comprising:
in the second route processor, receiving a second registration message from the second user where the second registration message has the fifth address as a second registration message source address and a sixth address as a second registration message destination address, processing the second registration message to change the fifth address to the seventh address and to change the sixth address to a fourth address, and transferring the second registration message;
in a soft switch, receiving and processing the second registration message to register the second user at the seventh address;
in the first route processor, receiving a first request message from the first user where the request message requests a session with the second user and has the first address as a first request message source address and a second address as a first request message destination address, processing the first request message to change the first address to the third address and to change the second address to the fourth address, and transferring the first request message;
in a soft switch, receiving and processing the first request message to transfer a first response message that associates the second user with the seventh address and has the fourth address as a first response message source address and the third address as a first response message destination address;
in the first route processor, receiving and processing the first response message to change the fourth address to the second address and to change the third address to the first address, and transferring the first response message to the first user;
in the first route processor, receiving a second request message from the first user where the second request message has the first address as a second request message source address and the seventh address as a second request message destination address, processing the second request message to change the first address to the third address, and transferring the second request message;
in the second route processor, receiving and processing the second request message to change the seventh address to the fifth address and transferring the second request message;
in the second route processor, receiving and processing a second response message from the second user where the second response message has the fifth address as a second response message source address and the third address as a second response message destination address, processing the second response message to change the fifth address to the seventh address, and transferring the second response message; and
in the first route processor, receiving and processing the second response message to change the third address to the first address, and transferring the second response message.

13. A method of operating a communication system for users wherein the communication system includes route processors, an Internet Protocol (IP) network, and a soft switch, the method comprising:
establishing IP routes between the route processors through the IP network;
in the route processors, changing signaling message addresses in signaling messages that are transferred between the users and the soft switch to direct the signaling messages through the route processors;
in the route processors, changing data message addresses in data messages that are transferred between the users to direct the data messages through the route processors;
transferring the data messages between the route processors over the IP routes; and
in the route processors, monitoring performance of the IP routes.

15. The method of claim 13 wherein the signaling messages comprise Session Initiation Protocol messages.

15. The method of claim 13 wherein the signaling messages comprise H.323 messages.

16. The method of claim 13 wherein the data messages comprise Real-Time Protocol messages.

17. The method of claim 13 wherein the IP routes comprises Resource Reservation Protocol tunnels.

18. The method of claim 13 wherein monitoring the performance of the IP routes comprises monitoring packet delay.

19. The method of claim 13 further comprising selecting ones of the IP routes to use based on the monitored performance of the IP routes.

20. The method of claim 13 further comprising transferring information indicating performance of the IP routes from the route processors to a route manager.
